(19) United States
(12) Patent Application Publication
(10) Pub. No.: US 2017/0279131 A1
(43) Pub. Date: Sep. 28, 2017

(54) BIPOLAR PLATE OF AN ELECTROCHEMICAL CELL WITH IMPROVED MECHANICAL STRENGTH

(71) Applicant: Commissariat a l'energie atomique et aux energies alternatives, Paris (FR)

(72) Inventor: Jean-Philippe POIROT-CROUVEZIER, Saint Georges De Commiers (FR)

(73) Assignee: Commissariat a l'energie atomique et aux energies alternatives, Paris (FR)

(21) Appl. No.: 15/467,320

(22) Filed: Mar. 23, 2017

(30) Foreign Application Priority Data
Mar. 24, 2016 (FR) 16 52545

(51) Int. Cl. H01M 8/0258; H01M 8/0226; H01M 8/0206; H01M 8/0267; H01M 8/0247

(52) U.S. Cl. CPC H01M 8/0258; H01M 8/0267; H01M 8/0247; H01M 8/0206; H01M 8/0226

(57) ABSTRACT

A bipolar plate of an electrochemical cell, including a first conductive sheet and a second conductive sheet, wherein at least one first distribution channel of a first conductive sheet and one second distribution channel of a second conductive sheet each include at least one portion, referred to as a superposed portion, where they are superposed onto one another and make mutual contact via their respective back walls, and at least one portion, referred to as a reinforcement portion, where they make contact, via their respective back walls, with a dividing rib of the opposite conductive sheet.

### TECHNICAL FIELD

The field of the invention is that of electrochemical reactors including a stack of electrochemical cells, such as fuel cells and electrolysers, and more specifically relates to bipolar plates, of conductive sheet type, located between the electrodes of adjacent electrochemical cells.

### STATE OF THE PRIOR ART

An electrochemical reactor, such as a fuel cell or an electrolyser, conventionally includes a stack of electrochemical cells, each of which comprises an anode and a cathode that are electrically separated from each other by an electrolyte, an electrochemical reaction taking place in the cells between two reactants that are continuously fed thereto.

In a general manner, in the case of a fuel cell, the fuel (for example hydrogen) is brought into contact with the anode, while the oxidant (for example oxygen) is brought into contact with the cathode. The electrochemical reaction is subdivided into two half-reactions, an oxidation reaction and a reduction reaction, which take place at the anode/electrolyte interface and at the cathode/electrolyte interface, respectively. To take place, the electrochemical reaction requires the presence of an ionic conductor between the two electrodes, namely the electrolyte, which is for example contained in a polymer membrane, and an electronic conductor formed by the external electrical circuit. The stack of cells is thus the site of the electrochemical reaction: the reactants must be supplied thereto and the products and any unreactive species must be removed therefrom, as must the heat produced during the reaction.

The electrochemical cells are conventionally separated from one another by bipolar plates that ensure the electrical interconnection of the cells. The bipolar plates usually include an anodic face, on which a circuit for distributing fuel is formed, and a cathodic face, opposite the anodic face, on which a circuit for distributing oxidant is formed. Each distributing circuit takes the form of a network of channels that are, for example, arranged in parallel or have undulations, or are transversely offset, in the plane (X, Y) of the bipolar plate, in order to bring the reactive species uniformly to the corresponding electrode. The bipolar plates may also include a cooling circuit formed from a network of internal ducts that allow a heat-transfer fluid to flow and thus the heat produced locally during the reaction in the cell to be removed.

Each bipolar plate may be formed from two electrically conductive sheets that are bonded to one another in the direction of stacking of the electrochemical cells. They feature reliefs, or embossments, forming both the channels of the distribution circuits on the outer faces of the sheets, and the channels of the cooling circuit between the inner faces of the sheets. The conductive sheets may be made of metal and the reliefs formed by stamping.

The bipolar plates also have a mechanical function to the extent that they ensure the transmission of a clamping force within the stack of electrochemical cells, this mechanical force helping to improve the quality of the electrical contact between the electrodes and the bipolar plates of the electrochemical cells. As such, there is a need for bipolar plates with conductive sheets having improved mechanical strength.

### DISCLOSURE OF THE INVENTION

The objective of the invention is to remedy at least in part the drawbacks of the prior art, and more particularly to propose a bipolar plate of an electrochemical cell with improved mechanical strength. To achieve this, the subject of the invention is a bipolar plate of an electrochemical cell, including a first conductive sheet and a second conductive sheet, each including an inner face and an opposite outer face, bonded to one another by the inner faces, and each including reliefs forming, on the outer faces, distribution channels that are intended to distribute reactive gases.

The distribution channels of one and the same conductive sheet are separated pairwise by a dividing rib intended to make contact with an electrode of an electrochemical cell, and each distribution channel includes a back wall connected to the adjacent dividing ribs.

According to the invention, at least one first distribution channel of the first conductive sheet and one second distribution channel of the second conductive sheet each include:
at least one portion, referred to as a superposed portion, where they are superposed onto one another and make mutual contact via their respective back walls, and
at least one portion, referred to as a reinforcement portion, where they make contact, via their respective back walls, with a dividing rib of the opposite conductive sheet.

Certain preferred, but non-limiting, aspects of this bipolar plate are the following:

A first reinforcement portion of the first distribution channel may be transversally juxtaposed with a second reinforcement portion of the second distribution channel, the first reinforcement portion making contact with a dividing rib that borders the second distribution channel, and the second reinforcement portion making contact with a dividing rib that borders the first distribution channel.

The first distribution channel and/or the second distribution channel may each include, between a superposed portion and a reinforcement portion, a zone where it does not make contact with the opposite conductive sheet, thus allowing a local communication of fluid between adjacent cooling channels.

Each of said distribution channels may include a plurality of superposed portions and of reinforcement portions, which are longitudinally arranged in an alternate manner.

Reinforcement portions of one distribution channel may be positioned in a longitudinally offset manner with respect to reinforcement portions of an adjacent distribution channel.

A conductive sheet may include distribution channels each including superposed portions and reinforcement portions, said distribution channels having a longitudinal axis that is substantially rectilinear or has transverse undulations.

The opposite conductive sheet may include distribution channels each including superposed portions and reinforcement portions, some of which have a longitudinal axis that is substantially rectilinear and others of which have a longitudinal axis that has transverse undulations with respect to a rectilinear longitudinal axis.

Distribution channels of the first conductive sheet may have a longitudinal axis that has transverse undulations in a first direction, and distribution channels of the second conductive sheet may have a longitudinal axis that has transverse undulations in a second direction, opposite the first direction.

The first conductive sheet may include a number of distribution channels that is smaller than the number of distribution channels of the second conductive sheet, at least one dividing rib of the first conductive sheet having a transverse dimension that varies longitudinally.

The second conductive sheet may be intended to make contact with a cathode of an electrochemical cell while the first conductive sheet may be intended to make contact with an anode of an adjacent electrochemical cell.

A reinforcement portion may take the form of an excrescence of the distribution channel in the direction of the opposite conductive sheet, said distribution channel having a local depth that is deeper than a local depth at a superposed portion.

The invention also pertains to an electrochemical cell, including:
a bipolar plate according to any one of the preceding features;
a membrane/electrode assembly, one of said electrodes of which is in contact with the first or the second conductive sheet of the bipolar plate.

### BRIEF DESCRIPTION OF THE DRAWINGS

Other aspects, aims, advantages and features of the invention will become more clearly apparent upon reading the following detailed description of preferred embodiments thereof, which description is provided by way of non-limiting example and with reference to the appended drawings, in which:

FIGS. 1A and 1B are cross-sectional views schematically illustrating a bipolar plate according to a first embodiment, which plate is located between two membrane/electrode assemblies, the anodic and cathodic distribution channels of which have superposed portions (FIG. 1A) and reinforcement portions (FIG. 1B);

FIG. 2 is an exploded view in perspective of a portion of the bipolar plate according to the first embodiment;

FIGS. 3A to 3G are cross-sectional views of the bipolar plate portion illustrated in FIG. 2, showing the alternation of the superposed portions and the reinforcement portions of the anodic and cathodic distribution channels;

FIG. 4 is an exploded view in perspective of a portion of the bipolar plate according to a second embodiment, in which some of the anodic distribution channels extend along a rectilinear longitudinal axis and others extend along a longitudinal axis with transverse undulations;

FIGS. 5A to 5I are cross-sectional views of the bipolar plate portion illustrated in FIG. 4, showing the alternation of the superposed portions and the reinforcement portions of the anodic and cathodic distribution channels;

FIG. 6 is an exploded view in perspective of a portion of the bipolar plate according to a third embodiment, in which the anodic distribution channels extend along a longitudinal axis with transverse undulations and the cathodic distribution channels extend along a rectilinear longitudinal axis;

FIGS. 7A to 7Q are cross-sectional views of the bipolar plate portion illustrated in FIG. 6, showing the alternation of the superposed portions and the reinforcement portions of the anodic and cathodic distribution channels.

### DETAILED DESCRIPTION OF PARTICULAR EMBODIMENTS

In the figures and in the subsequent description, the same references represent identical or similar elements. Moreover, the various elements are not represented to scale so as to enhance the clarity of the figures. Furthermore, the various embodiments and variants are not mutually exclusive and may be combined with one another.

Various embodiments and variants will be described with reference to a fuel cell and in particular to a PEM (proton exchange membrane) fuel cell, the cathode of which is supplied with oxygen and the anode of which with hydrogen. However, the invention is applicable to any type of fuel cell, and in particular to those operating at low temperatures, i.e. temperatures below 200° C., and to electrochemical electrolysers.

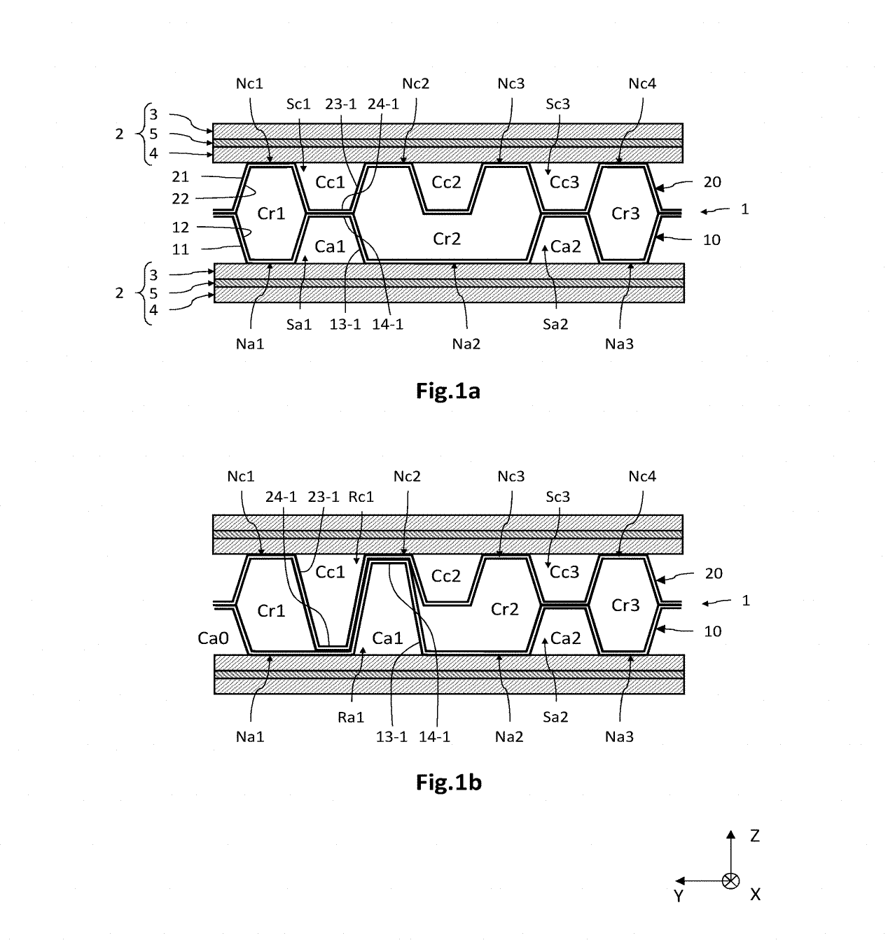

FIGS. 1A and 1B are partial schematic illustrations of an exemplary bipolar plate 1 of an electrochemical cell according to a first embodiment. The electrochemical cells here belong to a stack of cells of a fuel cell. Each electrochemical cell includes a membrane/electrode assembly 2 formed from an anode 3 and a cathode 4 that are separated from each other by an electrolyte 5, here comprising a polymer membrane. The membrane/electrode assemblies 2 of the electrochemical cells are placed between bipolar plates 1 that are capable of bringing reactive species to the electrodes and of removing the heat produced during the electrochemical reaction.

A direct orthonormal coordinate system (X,Y,Z) is defined here and will be referred to in the rest of the description, where the Z axis is oriented along the thickness of the bipolar plate and hence along the axis of stacking the electrochemical cells, and where the X and Y axes define a plane parallel to the plane of the bipolar plates.

In a manner known per se, each electrode 3, 4 includes a gas diffusion layer (GDL), placed in contact with a bipolar plate 1, and an active layer located between the membrane 5 and the diffusion layer. The active layers are the site of electrochemical reactions. They include materials allowing the oxidation and reduction reactions at the respective interfaces of the anode and cathode with the membrane to take place. The diffusion layers are made from a porous material that permits the diffusion of the reactive species from the distributing circuit of the bipolar plates 1 to the active layers, and the diffusion of the products generated by the electrochemical reaction to the same distributing circuit.

Each bipolar plate 1 is formed from two conductive sheets 10, 20 that are bonded and joined to one another, these conductive plates being stamped so as to form circuits for distributing reactive gases over the electrodes 3, 4 of each of the electrochemical cells, and a cooling circuit located between the conductive sheets 10, 20. Thus, a first conductive sheet 10, referred to as an anodic conductive sheet, is intended to make contact with the anode 3 of a membrane/electrode assembly 2 of an electrochemical cell, while the second conductive sheet 20, referred to as a cathodic conductive sheet, is intended to make contact with the cathode 4 of a membrane/electrode assembly 2 of an adjacent electrochemical cell.

Each conductive sheet 10, 20 includes an outer face 11, 21 and an opposite inner face 12, 22, the conductive sheets 10, 20 being bonded to one another by the inner faces 12, 22. An outer face 11, 21 is referred to as an anodic outer face when it is intended to make contact with the anode 3 of an electrochemical cell, or as a cathodic outer face when it is intended to make contact with the cathode 4 of the adjacent electrochemical cell. The anodic face of a conductive sheet 10, 20 includes the circuit for distributing a reactive gas, for example hydrogen, and the cathodic face of the other conductive sheet includes a circuit for distributing a reactive gas, for example air or oxygen.

The conductive sheets 10, 20 take the form of laminae, or elementary plates of low thickness, made of an electrically conductive material, for example a metal or even a composite, for example a graphite-filled composite. The thickness may be of the order of a few tens of microns up to a few hundred microns, for example from around 50 p.m to 200 p.m in the case of metal sheets.

The conductive sheets include reliefs, or embossments, obtained for example by stamping or forming in a press, the form of which on one face is complementary to the form on the opposite face. These reliefs form, on the outer faces 11, 21, the circuits for distributing reactive gases and, on the inner faces 12, 22, a cooling circuit including channels through which a heat-transfer fluid is intended to flow.

Each distribution channel Ca1, Cc1 . . . is formed from lateral walls 13-1, 23-1 . . . which extend substantially along the Z axis of the thickness of the bipolar plate 1, these lateral walls 13-1, 23-1 . . . being connected to one another by a back wall 14-1, 24-1 . . . . Each distribution channel Ca1, Cc1 . . . is separated from the neighbouring channels of the same distribution circuit by a wall, referred to as a dividing rib Na1, Nc1 . . . , which connects the adjacent lateral walls of two adjacent distribution channels, this dividing rib being intended to come into contact with the corresponding electrode. Stated otherwise, the anodic Ca1, Ca2 . . . and cathodic Cc1, Cc2 . . . distribution channels are separated pairwise by respective anodic Na1, Na2 . . . and cathodic Nc1, Nc2 . . . dividing ribs. The dividing rib is a wall the surface of which is preferably substantially planar.

It is possible to define a local depth of a distribution channel as the dimension along the Z axis between the back wall of the channel and a plane passing through the adjacent dividing ribs. It is also possible to define a local width of a dividing rib as the dimension of the rib in cross section. Furthermore, the term “adjacent”, or “transversally adjacent”, is understood to mean juxtaposed along an axis that is transverse to the longitudinal axis of a distribution channel.

According to the invention, at least one first distribution channel of the first conductive sheet and one second distribution channel of the second conductive sheet each include:
at least one portion, referred to as a superposed portion, where they are superposed onto one another and make mutual contact via their respective back walls, and
at least one portion, referred to as a reinforcement portion, where they make contact, via their respective back walls, with a dividing rib of the opposite conductive sheet.

As illustrated in FIG. 1A, which shows a first cross section of the bipolar plate 1, at least one anodic Ca1 and one cathodic Cc1 distribution channel are superposed onto one another and make mutual contact via their respective back walls 14-1, 24-1, this taking place at a respective portion referred to as a superposed portion Sa1, Sc1. The term “superposed portion” is understood to mean that the distribution channel in question is placed facing or in line with, i.e. perpendicular to, a distribution channel of the opposite conductive sheet, along the Z axis corresponding to the thickness of the bipolar plate 1. In this configuration, the depth of each distribution channel Ca1, Cc1 is, in its superposed portion Sa1, Sc1, a depth referred to as a nominal depth.

In this example, not all of the cathodic channels are superposed or in contact with anodic channels. This is the case here with the cathodic channel Cc2, located between the cathodic channels Cc1 and Cc3, which is not superposed onto an anodic channel. This absence of anodic channels facing certain cathodic channels results in the presence of anodic dividing ribs of various widths. Thus, the anodic ribs Na1 and Na3 are referred to as narrow ribs and have a first width, to the extent that they each separate anodic channels the superposed portion of which makes contact with adjacent cathodic channels. However, the anodic rib Na2 is referred to as a wide anodic rib and has a second width that is wider than the first width, to the extent that it separates two anodic channels Ca1, Ca2 with superposed portions that are in contact with non-adjacent, i.e. not transversally juxtaposed, cathodic channels Cc1, Cc3. Thus, the width of the wide anodic rib Na2 is substantially equal to the sum of the widths of the cathodic ribs Nc2 and Nc3 and of the width of the cathodic channel Cc2.

This configuration is advantageous to the extent that the cooling channel Cr2, delimited in particular by the wide anodic rib Na2, has a large flow cross section, larger than that of the cooling channels Cr1, Cr3 that are located on the narrow anodic ribs Na1, Na3. This configuration is referred to as an enhanced flow configuration since this large flow cross section results in a decrease in local head losses in the cooling channel Cr2, thereby helping to locally improve the flow of the heat-transfer fluid and hence the removal of heat produced by the electrochemical cells in operation.

As illustrated in FIG. 1B, which shows a second cross section of the bipolar plate 1, the anodic Ca1 and cathodic Cc1 distribution channels additionally comprise a reinforcement portion Ra1, Rc1, different from the superposed portion Sa1, Sc1, where they each make contact, via their respective back walls 14-1, 24-1, with a dividing rib of the opposite conductive sheet, here the ribs Na1 and Nc2.

In this example, the anodic channel Ca1 makes contact, via the back wall 14-1 of the reinforcement portion Ra1, with a cathodic dividing rib, here the rib Nc2 located between the cathodic channels Cc1 and Cc2. It is thus transversally offset with respect to the longitudinal axis of the cathodic channel Cc1, so as to face and make contact with the cathodic rib Nc2. Likewise, the cathodic channel Cc1 makes contact, via the back wall 24-1 of the reinforcement portion Rc1, with an anodic dividing rib, here the rib Na1 located between the anodic channels Ca0 and Ca1.

The reinforcement portions Ra1, Rc1 take the form of a excrescence of the channel in the direction of the opposite conductive sheet, so as to come into contact with a dividing rib. The distribution channels then have a maximum local depth.

Preferably, the reinforcement portions Ra1, Rc1 of the anodic Ca1 and cathodic Cc1 channels are adjacent to one another, i.e. directly neighbouring, or juxtaposed with, one another in a transverse direction. In this situation, a lateral wall 13-1 of the anodic reinforcement portion Ra1 is located adjacently, potentially with mechanical contact, to a lateral wall 23-1 of the cathodic reinforcement portion Rc1. Stated otherwise, a reinforcement portion Ra1 of the anodic channel Ca1 is adjacent to a reinforcement portion Rc1 of the cathodic channel Cc1, the anodic reinforcement portion Ra1 making contact with a cathodic dividing rib Nc2 that borders the cathodic distribution channel Cc1, and the cathodic reinforcement portion Rc1 making contact with a dividing rib Na1 that borders the anodic distribution channel Ca1.

This configuration results in a local mechanical reinforcement of the bipolar plate to the extent that the lateral walls of each reinforcement portion here allow the mechanical clamping forces to be transmitted directly into a membrane/electrode assembly of a membrane/electrode assembly cell of the neighbouring cell. With a constant clamping force, there is therefore a decrease in the mechanical stresses to which the conductive sheets are subjected with respect to the configuration of FIG. 1A since, in a plane (X, Y), four, rather than two, lateral walls transmit the clamping force. Moreover, the transmission of the mechanical forces is improved to the extent that the mechanical forces are transmitted directly from a back wall of one conductive sheet to a dividing rib of the opposite conductive sheet. It is then possible to decrease the thickness of the conductive sheets, for example from 75 μm to 50 μm, while retaining equivalent mechanical strength, which results in a decrease in the overall thickness of the bipolar plate and hence an increase in the compactness of the stack of electrochemical cells.

It is preferable for a plurality of distribution channels of the distribution circuits to include superposed portions and reinforcement portions positioned alternately along the longitudinal axis of the channels. The term “alternate” is understood to mean that the superposed portions and the reinforcement portions come one after the other in turns repeatedly, either periodically or not periodically, along the longitudinal axis of the channel.

Thus, by virtue of the anodic and cathodic distribution channels including superposed portions in mutual contact in a first zone and reinforcement portions in a second zone, the mechanical strength of the bipolar plate is thus improved while retaining zones of enhanced flow. Moreover, as will be explained below, the alternation of the superposed portions and the reinforcement portions along the longitudinal axis of the distribution channel may result in a local communication of fluid between adjacent cooling channels, thereby allowing a transverse mixing of the flow of heat-transfer fluid along its longitudinal axis, thus improving the removal of heat produced by the electrochemical cells in operation.

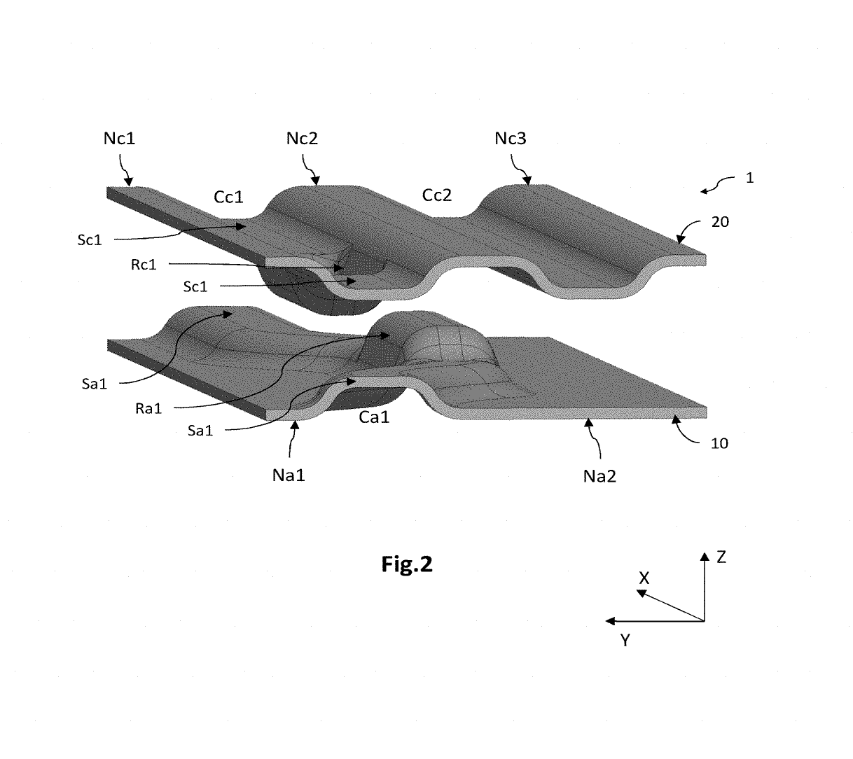

FIG. 2 is an exploded view in perspective of a portion of the bipolar plate 1 according to the first embodiment illustrated in FIGS. 1A and 1B.

The anodic distribution channel Ca1 alternates longitudinally between a superposed portion Sa1, where it is superposed onto and in contact with the superposed portion Sc1 of the cathodic distribution channel Cc1, and a reinforcement portion Ra1, where it is in contact with a dividing rib of the cathodic conductive sheet 20, here the cathodic rib Nc2. The cathodic distribution channel Cc1 alternates longitudinally between a superposed portion Sc1, which is superposed onto and in contact with the superposed portion Sa1 of the anodic channel Ca1, and a reinforcement portion Rc1, which is in contact with a dividing rib of the anodic conductive sheet 10, here the anodic rib Na1.

In this example, the anodic reinforcement portion Ra1 makes contact with the cathodic rib Nc2, but, as a variant, it could make contact with another cathodic rib, for example the rib Nc3. Likewise, the cathodic reinforcement portion Rc1 makes contact with the anodic rib Na1, but it could, as a variant, make contact with another anodic rib.

Communication between the superposed portions Sa1 and the reinforcement portions Ra1 is here achieved via a transverse undulation, or transverse offset, of the anodic channel Ca1 with respect to a main axis here passing through the superposed portions Sa1, this axis here being parallel to the rectilinear longitudinal axis of the cathodic distribution channel Cc1 with which the superposed portions Sa1 are in contact. The term “transverse undulation” is understood to mean that the distribution channel locally features a transverse offset, in the plane (X, Y), with respect to a main axis along which the channel extends.

Alternatively, the anodic channel Ca1 may include no undulations, and the cathodic channel Cc1 may then include a transverse undulation so that the reinforcement portion Rc1 comes into contact with an anodic dividing rib. As a variant, the anodic Ca1 and cathodic Cc1 channels may include transverse undulations so that the respective reinforcement portions Ra1 and Rc1 face and come into contact with an opposite dividing rib.

Furthermore, the length of the superposed portions and of the reinforcement portions of the distribution channels results from an optimization of the mechanical reinforcement of the bipolar plate by virtue of the spatial distribution of the reinforcement portions on the one hand, and the spatial distribution of the enhanced flow sections that are located on the superposed portions on the other hand.

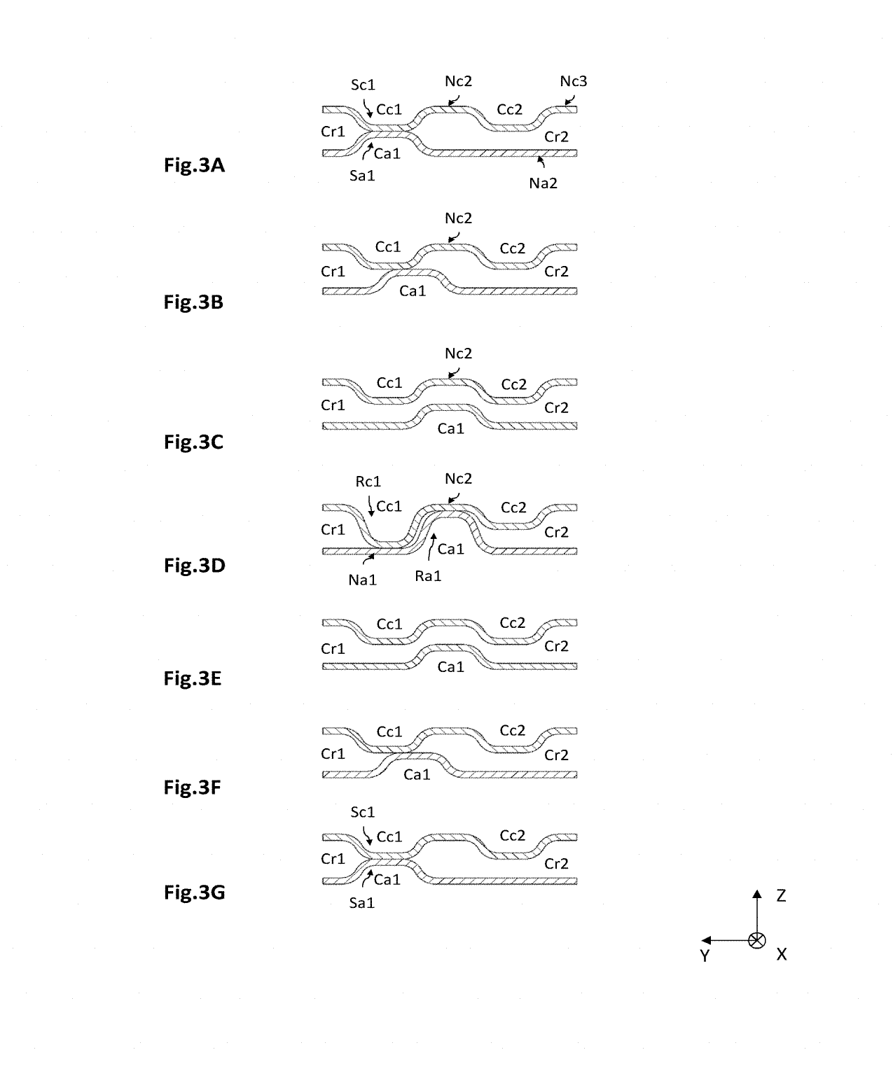

FIGS. 3A to 3G are a plurality of cross-sectional views of the bipolar plate shown in FIG. 2, illustrating an alternation of the superposed portions and the reinforcement portions of the distribution channels.

FIG. 3A shows the anodic Ca1 and cathodic Cc1 channels superposed onto one another at their superposed portions Sa1 and Sc1, which make mutual contact via their respective back walls. The channels Ca1 and Cc1 are at their nominal depth. The width of the dividing rib Na2 is wider than those of the facing dividing ribs Nc2 and Nc3, to the extent that there is no anodic channel facing the cathodic channel Cc2. The cooling channel Cr2 located on the anodic rib Na2 then has a substantial flow cross section, which results in a decrease in local head losses, thereby improving the quality of the flow and hence the local removal of heat. This configuration is referred to as an enhanced flow configuration.

FIGS. 3B and 3C show the anodic channel Ca1 in an intermediate portion that plays the role of a transition, taking the form of an undulation or transverse offset, between the superposed portion Sa1 (FIG. 3A) and the reinforcement portion Ra1 (FIG. 3D). In this intermediate portion, the anodic channel Ca1 is transversally offset with respect to the longitudinal axis of the cathodic channel Cc1 so as to gradually come to face a cathodic dividing rib, here the rib Nc2. Its depth in this intermediate portion is the nominal depth. Furthermore, the intermediate portion includes a zone, illustrated in FIG. 3C, in which the channels Ca1 and Cc1 are no longer in mutual contact, thereby resulting in a communication of fluid between the cooling channels Cr1 and Cr2. This communication of fluid results in a substantial decrease in local head losses and allows a transverse mixing of the flow of heat-transfer fluid between the cooling channels, thereby improving the uniformity of removal of heat produced by the electrochemical cells in operation.

FIG. 3D shows the anodic channel Ca1 at its reinforcement portion Ra1, i.e. in its portion where the back wall makes contact with an opposite cathodic rib, here the rib Nc2. The cathodic channel Cc1 also has a reinforcement portion Rc1 that comes into direct contact with the opposite anodic rib Na1. The reinforcement portions Ra1, Rc1 take the form of an excrescence of the channel in the direction of the opposite conductive sheet, with a maximum depth that is deeper than the nominal value. The anodic channel Ca1 is then no longer superposed, in the stacking direction Z, with the cathodic channel Cc1. Thus, by virtue of the distribution channels Ca1 and Cc1 being directly supported by an opposite dividing rib, the mechanical stresses to which the bipolar plate is subjected are locally decreased and the transmission of forces is improved, thereby helping to improve the mechanical strength of the bipolar plate.

FIGS. 3E and 3F show the anodic channel Ca1 in the intermediate portion that plays the role of a transition, here taking the form of an undulation or transverse offset, between the reinforcement portion Ra1 (FIG. 3D) and the downstream superposed portion Sa1 (FIG. 3G). This portion is thus similar to that shown in FIGS. 3B and 3C. The anodic channel Ca1 is transversally offset with respect to the longitudinal axis of the cathodic channel Cc1 so as to gradually come to face a cathodic channel, here the channel Cc1. In this intermediate portion, its depth is once again the nominal depth, like the cathodic channel Cc1. The intermediate portion here also includes a zone, illustrated in FIG. 3E, in which the channels Ca1 and Cc1 are no longer in mutual contact, which results in a communication of fluid between the cooling channels Cr1 and Cr2, thereby allowing the flow between these cooling channels to mix, and results in a decrease in local head losses, thereby improving the uniformity of heat removal by the heat-transfer fluid.

FIG. 3G shows the anodic channel Ca1 at a news superposed portion Sa1 in which it is superposed onto and in contact with the cathodic channel Cc1 in its superposed portion Sc1. This configuration is identical to that illustrated in FIG. 3A.

Advantageously, a plurality of distribution channels alternates longitudinally between superposed portions and reinforcement portions. This alternation may or may not be periodic, and the lengths of the reinforcement portions and of the superposed portions may or may not be identical, depending on the desired distribution of mechanical stresses and on the distribution of the zones with low local head losses within the distribution circuits and the cooling circuit.

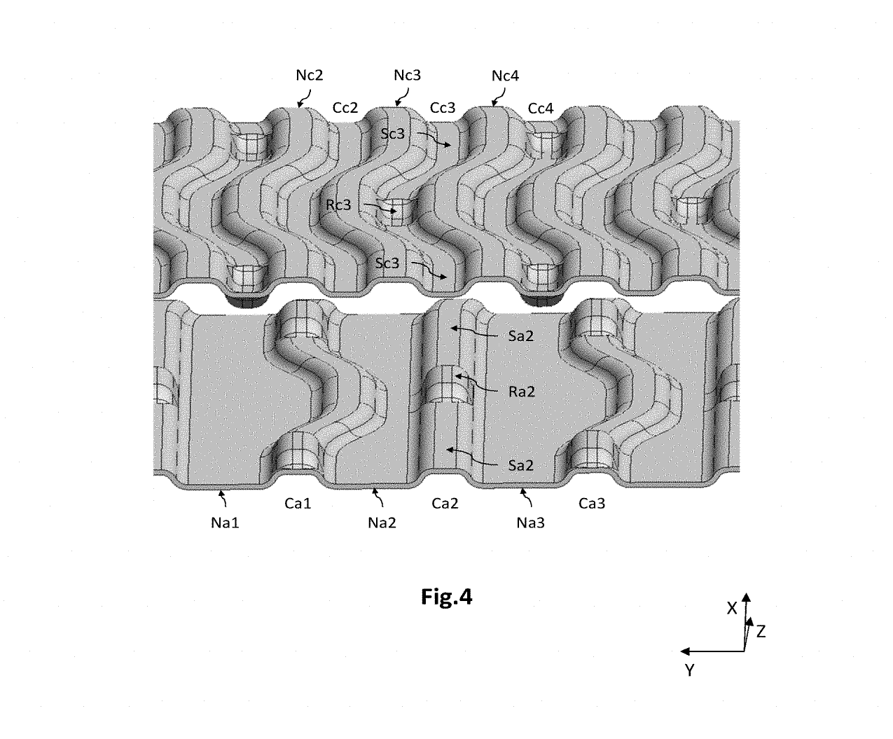

FIG. 4 is an exploded view in perspective of a portion of the bipolar plate 1 according to a second embodiment. This embodiment is mainly distinguished from the first embodiment in that the cathodic distribution channels extend along a longitudinal axis with transverse undulations, and in that some of the anodic distribution channels extend along a rectilinear longitudinal axis while others extend along a longitudinal axis with transverse undulations.

The anodic channel Ca2 here includes a longitudinal alternation between superposed portions Sa2 and reinforcement portions Ra2, here along a substantially rectilinear axis. The superposed portions Sa2 are superposed onto and make contact with the opposite cathodic channel Cc3 at its superposed portions Sc3; and the reinforcement portions Ra2 make contact with a cathodic dividing rib, here the rib Nc4.

Moreover, the anodic channels Ca1 and Ca3 that are adjacent to the channel Ca2 here include transverse undulations, i.e. transverse offsets here in the direction −Y, between two successive reinforcement portions. Thus, the dividing ribs that are located between the undulating channels and the rectilinear channels, for example the width of the anodic ribs Na2 and Na3 varies longitudinally between a minimum value and a maximum value.

The cathodic channel Cc3 also includes an alternation between superposed portions Sc3 and reinforcement portions Rc3, here along a longitudinal axis that undulates with respect to the rectilinear longitudinal axis of the channel Ca2. The superposed portions Sa3 make contact with the opposite anodic channel Ca2 via the back wall of the latter, and the reinforcement portions Rc3 make contact with an anodic rib, here the rib Na2.

Furthermore, the cathodic distribution channels here all have mutually parallel transverse undulations. Thus, to the extent that the cathodic channels here are undulating and parallel to one another, the width of the cathodic dividing ribs is substantially constant along the longitudinal axis. In this example, the cathodic channels undulate in a direction +Y, in phase opposition to the undulations in the direction −Y of the undulating anodic channels. As explained below, these undulations of the cathodic channels and of certain anodic channels result in the formation of localized zones in which the conductive sheets are not in mutual contact, thereby resulting in the communication of fluid between these cooling channels and hence the mixing of the heat-transfer fluid, along with a decrease in local head losses, thereby improving the uniformity of heat removal by the heat-transfer fluid.

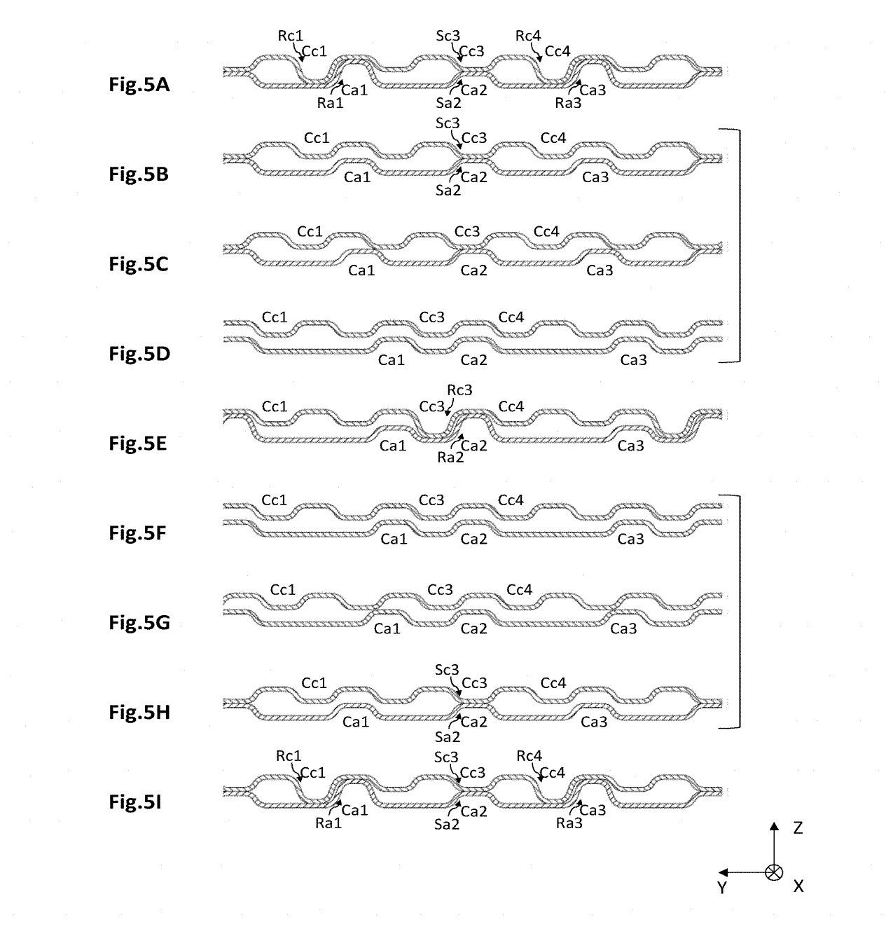

FIGS. 5A to 5I are cross-sectional views of the bipolar plate portion illustrated in FIG. 4, showing a sequence of alternations between the superposed portions and the reinforcement portions of distribution channels.

FIG. 5A illustrates a transverse section in which the anodic channel Ca2 has a superposed portion Sa2 in contact with the superposed portion Sc3 of the cathodic channel Cc3, i.e. the back wall of the anodic channel Ca2 is superposed onto and makes contact with the back wall of the cathodic channel Cc3. Furthermore, the anodic channel Ca2 neighbours two channels Ca1 and Ca3, which here have reinforcement portions Rat and Ra3, i.e. the back wall of these channels Ca1, Ca3 makes contact with a respective opposite cathodic dividing rib. Moreover, cathodic channels, here the channels Cc1 and Cc4, also have reinforcement portions Rc1 and Rc4, i.e. the back wall of these channels Cc1, Cc4 makes contact with a respective opposite anodic dividing rib.

FIGS. 5B, 5C et 5D illustrate an undulation sequence in which the channels Ca2 and Cc3 pass from their superposed portion Sa2 and Sc3 (FIG. 5A) to their reinforcement portion Ra2 and Rc3 (FIG. 5E). Thus, FIG. 5B shows the decrease in the depth of the anodic channels Ca1, Ca3 and of the cathodic channels Cc1, Cc4, from a maximum value to a nominal value. Next, FIGS. 5C and 5D show the transverse undulation of the cathodic channels in the direction +Y, and of some of the anodic channels in the opposite direction −Y. Thus, the anodic channel Ca2 remains rectilinear while the opposite cathodic channel Cc3 is transversally offset in the direction +Y. Moreover, the anodic channels Ca1 and Ca3 are transversally offset in the direction −Y while all of the cathodic channels are transversally offset in the direction +Y. The undulation ends when the anodic channel Ca2 is facing the cathodic rib Nc4 and the cathodic channel Cc3 is facing the anodic rib Nat.

In this undulation sequence, the anodic and cathodic channels have zones in which the conductive sheets are no longer locally in mutual contact, thereby allowing a communication of fluid between cooling channels. This is the case in FIG. 5B, where the decrease in the depth of the anodic channels Ca1 and Ca3 and of the cathodic channels Cc1 and Cc4 allows a communication of fluid between the cooling channels Cr1 and Cr2 on the one hand, and between the cooling channels Cr3 and Cr4 on the other hand. This is also the case in FIG. 5D, where the transverse undulation locally causes the communication of fluid between all of the cooling channels Cr1, Cr2, Cr3, Cr4. These communications of fluid between the cooling channels result in a decrease in local head losses, and allow the heat-transfer fluid to mix, thereby resulting in a uniform removal of heat produced by the electrochemical cells in operation.

FIG. 5E illustrates a cross section in which the anodic channel Ca2 has a reinforcement portion Ra2, and in which the cathodic channel Cc3 also has a reinforcement portion Rc3. Thus, the back wall of the channels Ca2, Cc3 makes contact with the dividing rib Nc4, Na2, respectively. In this example, the anodic channels Ca1, Ca3 are at their nominal depth, but they could alternatively have a reinforcement portion. This is also the case with the cathodic channels Cc1, Cc2, Cc4, Cc5.

FIGS. 5F, 5G and 5H illustrate another undulation sequence in which the anodic channel Ca2 and the cathodic channel Cc3 pass from their reinforcement portion Ra2, Rc3 (FIG. 5E) to their superposed portion Sa2, Sc3 (FIG. 51). There is thus a phase in which the depth of the channels decreases (FIG. 5F), which results in a communication of fluid being established between the cooling channels, followed by a phase of transverse undulation (FIG. 5G and 5H) in the direction −Y for the cathodic channels and in the opposite direction +Y for the anodic channels Ca1, Ca3, until the channels Ca2 and Cc3 are superposed onto one another in their respective superposed portions Sa2, Sc3.

FIG. 51 illustrates a cross section in which the channels Ca2 and Cc3 are superposed and in mutual contact at their respective superposed portions Sa2, Sc3; and in which the anodic channels Ca1, Ca3 and the cathodic channels Cc1 have a reinforcement portion. This section is identical to that of FIG. 5A and is not described in greater detail.

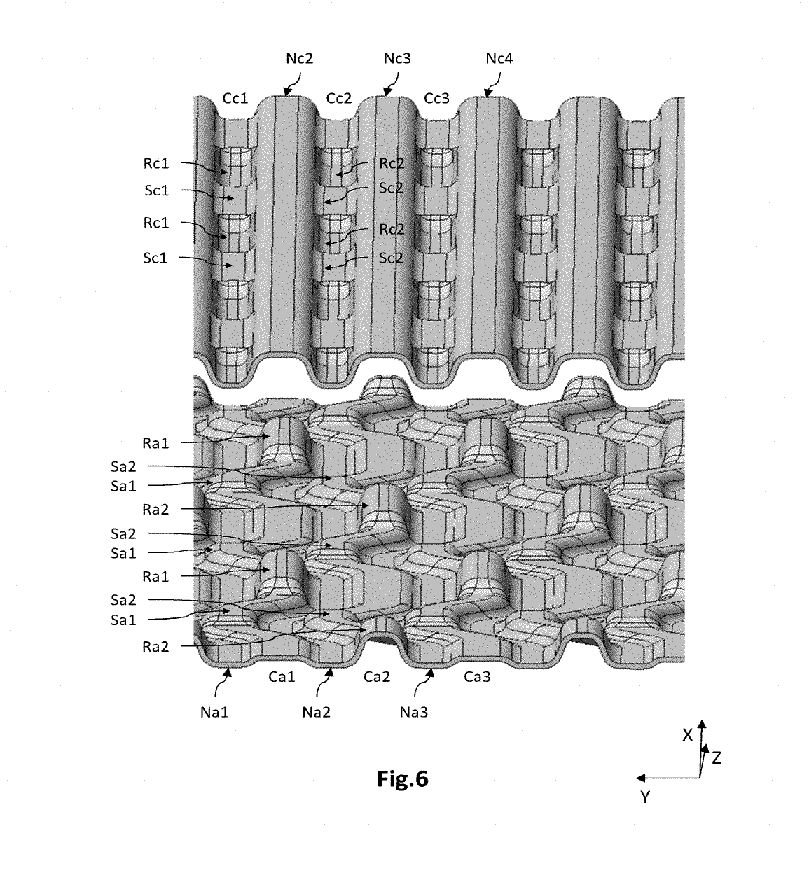

FIG. 6 is an exploded view in perspective of a portion of the bipolar plate according to a third embodiment. In this example, the number of anodic distribution channels is substantially equal to the number of cathodic distribution channels. The anodic and cathodic dividing ribs are substantially equal in width, this width being substantially constant along the longitudinal axis of the channels.

The cathodic channels Cc1, Cc2 . . . here each have an alternation of superposed portions Sc1, Sc2 . . . and reinforcement portions Rc1, Rc2 . . . along a substantially rectilinear longitudinal axis. The superposed portions Sc1, Sc2 . . . thus make contact with superposed portions Sa1, Sa2 . . . of the opposite anodic channels Ca1, Ca2 . . . . The reinforcement portions Rc1, Rc2 . . . make contact with the opposite anodic dividing ribs Na1, Na2 . . . .

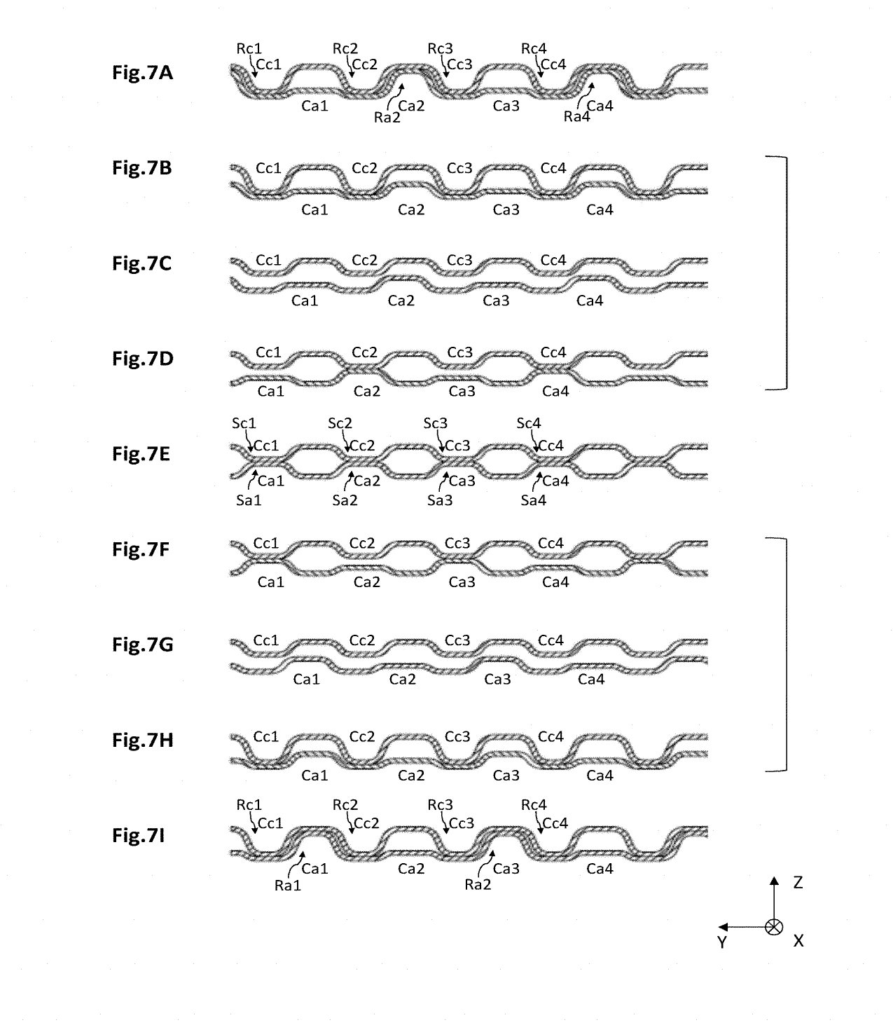

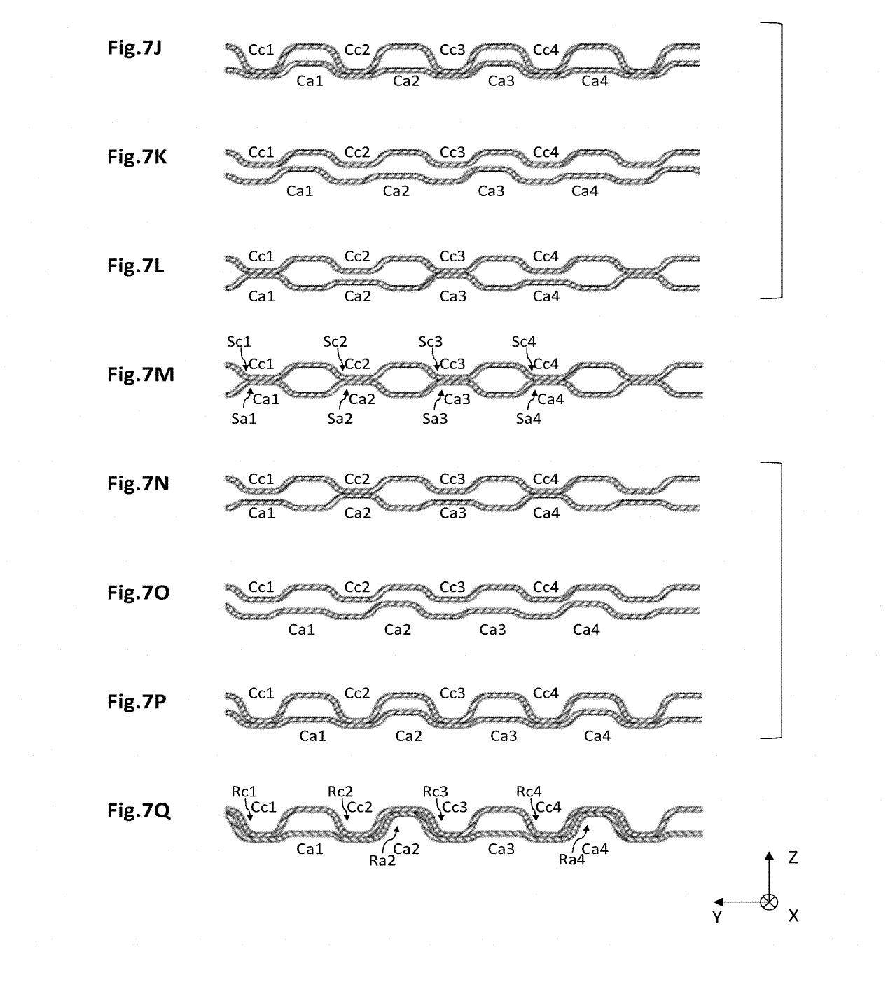

The anodic channels Ca1, Ca2 . . . here each have an alternation of superposed portions Sa1, Sa2 . . . and of reinforcement portions Rat, Ra2 . . . along a longitudinal axis that has transverse undulations, which are parallel to one another in this case. However, in order to allow the heat-transfer fluid to flow between the conductive sheets, the reinforcement portions of neighbouring anodic channels are longitudinally offset pairwise. Thus, when an anodic channel has a reinforcement portion the depth of the adjacent anodic channels is less than the maximum depth, so as thus to form a cooling channel between the two conductive sheets. In this example, the reinforcement portions of two neighbouring anodic channels have a longitudinal offset of half an undulation period. This arrangement thus increases the mixing of the flow of heat-transfer fluid, as explained with reference to FIGS. 7A to 7Q.

FIGS. 7A to 7Q are cross-sectional views of the bipolar plate portion illustrated in FIG. 6, showing a sequence of alternation between the superposed portions and the reinforcement portions.

FIG. 7A illustrates a cross section with reinforcement portions according to a first mechanical reinforcement configuration, in which the cathodic channels all have reinforcement portions on the one hand, and in which a first assembly of anodic channels has reinforcement portions while a second assembly of anodic channels does not have reinforcement portions. The cathodic channels Cc1, Cc2 . . . thus include reinforcement portions Rc1, Rc2 . . . such that there is contact between the back wall of each cathodic channel and an opposite anodic dividing rib Na1, Na2 . . . . Every other anodic channel here includes a reinforcement portion. Thus, the anodic channels Ca1, Ca4 include reinforcement portions Ra1, Ra4 and are thus at a maximum depth so as to come into contact with the opposite cathodic ribs. However, the anodic channels Ca1, Ca3 do not include a reinforcement portion and are at a minimum depth in order thus to form cooling channels with the opposite cathodic ribs.

FIG. 7E illustrates an intermediate cross section with superposed portions according to an enhanced flow configuration, in which the anodic and cathodic channels have superposed portions. It is located between the sections with reinforcement portions of FIGS. 7A, 7I and 7Q. In this section, the cathodic channels Cc1, Cc2 . . . each have a portion Sc1, Sc2 . . . superposed onto and in contact with a superposed portion Sa1, Sa2 . . . of the anodic channels Ca1, Ca2 . . . .

FIG. 71 illustrates a cross section with reinforcement portions according to a second mechanical reinforcement configuration, in which the cathodic channels have reinforcement portions, and in which the first assembly of anodic channels does not have reinforcement portions while the second assembly of anodic channels does have them. It corresponds to half an undulation period between the reinforcement portions of the anodic channels. The configuration of the cathodic channels is identical to that of FIGS. 7A and 7Q. Furthermore, the anodic channels Ca1, Ca4 of the first assembly do not include a reinforcement portion and are at a minimum depth in order thus to form cooling channels with the opposite cathodic ribs. However, the anodic channels Ca1, Ca3 of the second assembly do include reinforcement portions Ra1, Ra3 and are thus at a maximum depth so as to come into contact with the opposite cathodic ribs.

FIG. 7M illustrates a cross section with superposed portions, similar to that of FIG. 7E, in which the anodic and cathodic channels have superposed portions.

Lastly, FIG. 7Q illustrates a cross section with reinforcement portions identical to that illustrated in FIG. 7A. These two sections correspond to an undulation period between the reinforcement portions of the anodic channels.

Located between the sections described above is a transverse undulation sequence in which the anodic channels undulate transversely with respect to the rectilinear longitudinal axis of the facing cathodic channels.

FIGS. 7B, 7C, 7D thus illustrate a transverse undulation sequence between FIG. 7A, with reinforcement portions according to a first configuration, and FIG. 7E, with superposed portions. The channels the depth of which was maximum at the reinforcement portions decrease in depth (FIG. 7B and 7C), then the anodic channels are transversally offset, here in the direction +Y, so as to come to face the cathodic channels (FIG. 7C and 7D), and lastly the anodic channels of minimum depth increase in depth in order to come into contact with the cathodic channels (FIG. 7D and 7E). Thus, an extended communication between the cooling channels is achieved in the section of FIG. 7C, which allows an extended mixing of the flow of heat-transfer fluid, then a pairwise local communication between adjacent cooling channels is achieved in the section of FIG. 7D.

FIGS. 7F, 7G, 7H also illustrate a transverse undulation sequence between FIG. 7E with superposed portions and FIG. 7I with reinforcement portions according to the second configuration. The anodic channels of the first channel assembly decrease in depth from the nominal value to a minimum value, thereby allowing a pairwise local communication between the adjacent cooling channels. Next, the anodic channels are transversely offset with respect to the cathodic channels, here in the direction −Y, so as to come to face the cathodic dividing ribs (FIG. 7G). A communication of fluid between the cooling channels is achieved in this section of FIG. 7G, thereby allowing an extended mixing of the flow of heat-transfer fluid. Lastly, the anodic channels of the second channel assembly increase in depth from the nominal value Pnom to the maximum value Pₘₐₓ so as to form reinforcement portions that come into contact with the cathodic ribs opposite.

Transverse undulation sequences occur between the sections of FIGS. 7I and 7M (FIG. 7J to 7L, similar to those of FIG. 7B to 7D) and between the sections of FIG. 7M and 7Q (FIG. 7N to 7P, similar to those of FIG. 7F to 7H), and are not described in greater detail here.

Thus, the mechanical strength of the bipolar plate is improved by virtue of the presence of anodic and cathodic reinforcement portions, while flow zones of the bipolar plate are enhanced by the presence of anodic and cathodic superposed portions.

Moreover, they have extended or local fluid communication zones between the cooling channels which allow the heat-transfer fluid to mix and the removal of heat produced by the electrochemical cells in operation to be improved.

Particular embodiments have just been described. Various modifications and variants will be apparent to a person skilled in the art.

Thus, it is possible for the transverse undulations not to be periodic. Moreover, it is possible for two successive reinforcement portions of one and the same distribution channel not to make contact with the same dividing rib of the opposite conductive sheet, but to make contact with different dividing ribs. Likewise, it is possible for two successive superposed portions of one and the same distribution channel not to make contact with the same distribution channel of the opposite conductive sheet, but to make contact with different distribution channels.

These various variants, optionally combined with one another and applied to the anodic distribution circuit and/or to the cathodic distribution circuit, may make it possible to optimize both the mechanical strength of the bipolar plate, the spatial distribution of the enhanced flow zones at the superposed portions, and the mixing of the flow of the heat-transfer fluid and of the cooling circuit.

1. A bipolar plate of an electrochemical cell, comprising a first conductive sheet and a second conductive sheet,
each including an inner face and an opposite outer face, bonded to one another by the inner faces, and
each including reliefs forming, on the outer faces, distribution channels that are configured to distribute reactive gases,
the distribution channels of one and the same conductive sheet being separated pairwise by a dividing rib configured to make contact with an electrode of an electrochemical cell, and
each distribution channel including a back wall connected to the adjacent dividing ribs, wherein at least one first distribution channel of the first conductive sheet and one second distribution channel of the second conductive sheet each include:
at least one portion, referred to as a superposed portion, where they are superposed onto one another and make mutual contact via their respective back walls, and
at least one portion, referred to as a reinforcement portion, where they make contact, via their respective back walls, with a dividing rib of the opposite conductive sheet.

2. The bipolar plate according to claim 1, wherein a first reinforcement portion of the first distribution channel is transversally juxtaposed with a second reinforcement portion of the second distribution channel, the first reinforcement portion making contact with a dividing rib that borders the second distribution channel, and the second reinforcement portion making contact with a dividing rib that borders the first distribution channel.

3. The bipolar plate according to claim 1, wherein the first distribution channel and/or the second distribution channel each include, between a superposed portion and a reinforcement portion, a zone where it does not make contact with the opposite conductive sheet, thus allowing a local communication of fluid between adjacent cooling channels.

4. The bipolar plate according to claim 1, wherein each of said distribution channels includes a plurality of superposed portions and of reinforcement portions, which are longitudinally arranged in an alternate manner.

5. The bipolar plate according to claim 4, wherein reinforcement portions of one distribution channel are positioned in a longitudinally offset manner with respect to reinforcement portions of an adjacent distribution channel.

6. The bipolar plate according to claim 1, wherein a conductive sheet includes distribution channels each including superposed portions and reinforcement portions, said distribution channels having a longitudinal axis that is substantially rectilinear or has transverse undulations.

7. The bipolar plate according to claim 6, wherein the opposite conductive sheet includes distribution channels each including superposed portions and reinforcement portions, some of which have a longitudinal axis that is substantially rectilinear and others of which have a longitudinal axis that has transverse undulations with respect to a rectilinear longitudinal axis.

8. The bipolar plate according to claim 6, wherein distribution channels of the first conductive sheet have a longitudinal axis that has transverse undulations in a first direction, and distribution channels of the second conductive sheet have a longitudinal axis that has transverse undulations in a second direction, opposite the first direction.

9. The bipolar plate according to claim 1, wherein the first conductive sheet includes a number of distribution channels that is smaller than the number of distribution channels of the second conductive sheet, at least one dividing rib of the first conductive sheet having a transverse dimension that varies longitudinally.

10. The bipolar plate according to claim 1, wherein the second conductive sheet is configured to make contact with a cathode of an electrochemical cell while the first conductive sheet is configured to make contact with an anode of an adjacent electrochemical cell.

11. The bipolar plate according to claim 1, wherein a reinforcement portion takes the form of an excrescence of the distribution channel in the direction of the opposite conductive sheet, said distribution channel having a local depth that is deeper than a local depth at a superposed portion.

12. An electrochemical cell, comprising:
bipolar plate according to claim 1;
a membrane/electrode assembly, one of said electrodes of which is in contact with the first or the second conductive sheet of the bipolar plate.
